(19) United States
(12) Patent Application Publication
(10) Pub. No.: US 2022/0261932 A1
(43) Pub. Date: Aug. 18, 2022

(54) DYNAMIC REAL ESTATE TICKER SYSTEM, METHODS, AND APPARATUS

(71) Applicant: Keller Williams Realty, Inc., Austin, TX (US)

(72) Inventors: John Keller, Austin, TX (US); Kaiser H.D. Kabir, Austin, TX (US); Mark Nicholas Law, Leander, TX (US)

(21) Appl. No.: 17/669,655

(22) Filed: Feb. 11, 2022

Related U.S. Application Data
(60) Provisional application No. 63/148,985, filed on Feb. 12, 2021.

(51) Int. Cl. G06Q 50/16

(52) U.S. Cl. CPC G06Q 50/16

(57) ABSTRACT

A system and method for generating a dynamic real estate ticker for a user device are disclosed. An example method includes storing property transaction information and property-related web browsing information that is related to a user. The method also includes determining a real estate state of the user, among a plurality of available real estate states, based on the property transaction information and the property-related web browsing information. The plurality of available real estate states includes at least three of a first-time buyer, a repeat-buyer, a new owner, a mid-term owner, a long-term owner, a renter, an owner-renter, a seller, or an investor. The method further includes determining real estate content for the dynamic ticker based on the determined real estate state of the user and the property-related web browsing information. The determined real estate content is transmitted to the user device for display within a dynamic ticker.

### PRIORITY CLAIM

This application claims priority to and the benefit as a non-provisional application of U.S. Provisional Patent Application No. 63/148,985 filed Feb. 12, 2021, the entire contents of which are hereby incorporated by reference and relied upon.

### BACKGROUND

Many people today often take online real estate websites and mobile applications for granted. These digital products, services, and destinations typically show available homes for sale or rent within a specific geographic area, such as a zip code or town. Some real estate digital products even provide estimated prices for homes. Before these digital products, the only way to locate available real estate was through printed magazines/newspapers, real estate agents, or word of mouth.

Known real estate digital products are buyer-agnostic. For instance, these known real estate digital products are concerned with property valuations and the display of housing information. Indeed, these known websites and mobile applications are often static in that the same real estate information is presented to all of the buyers. Of course, some digital products allow a buyer to filter real estate criteria, and even some digital products permit a buyer to filter their search criteria. However, such searches only narrow down the static information rather than specifically personalizing and/or tailoring the information for the buyer and dynamically updating the information based on learned characteristics of the buyer.

A need accordingly exists for determining real estate information that is specifically generated for a buyer and displayed in a generally unobtrusive manner.

### SUMMARY

Methods, apparatus, and systems are disclosed for providing dynamic real estate tickers. The methods, apparatus, and systems are configured to acquire user characteristic and/or profile information to determine real estate-related content for display in a real estate ticker. As disclosed herein, the real estate ticker may be configured for display in a web browser, configured for display as a plug-in to a web browser, configured for display as a desktop widget, configured for display via a text message, and/or configured for display as a widget for a mobile operating system or mobile application. The dynamic real estate ticker is configured to be displayed in a non-obtrusive manner but provide information that is useful to a user based on detected, declared, predicted, or otherwise determined real estate needs.

As disclosed herein, the methods, apparatus, and systems are configured to acquire a user's characteristic information to determine real estate-related content for display in a ticker. The characteristic information may include real estate search and/or browsing information including information indicative of a viewed neighborhood, zip code, or town in addition to residence type (e.g., home, apartment, condominium, etc.), purchase price, square footage, property features (e.g., pet friendly, pool, garage, single-level, etc.) and/or area features (e.g., parks, public transit, schools, shopping, freeway access, etc.). The methods, apparatus, and systems are configured to use the above-characteristic information to determine residence purchase information per neighborhood, zip code, town, etc. (e.g., content) that is displayed on the ticker.

The characteristic information may also include user state information (e.g., home ownership journey information), which is indicative as to whether the user is a first-time buyer, a second time buyer, a new owner, a mid-term owner, a long-term owner, a renter, an owner-renter, an investor, and/or a seller. The user state information may be determined based on website browsing information, residence transaction information, mortgage information, appliance/fixture information, etc. The methods, apparatus, and systems are configured to use this characteristic information to determine which type of real estate information/content is displayed in the ticker. For example, information regarding neighborhood pricing may be displayed to identified buyers while the dynamic ticker may display home improvement, maintenance, and/or home service information for users that are identified as new owners. In another example, information indicative of favorable real estate investments may be displayed to users that are identified as investors.

In light of the present disclosure and the above aspects, it is therefore an advantage of the present disclosure to provide a dynamic real estate ticker that updates automatically based on a determined real estate user state.

It is another advantage of the present disclosure to provide a dynamic real estate ticker that shows neighborhood property information for recommended neighborhoods.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a diagram that is illustrative of different real estate states of a user, according to an example embodiment of the present disclosure.

FIG. 2 is a diagram of an example real estate dynamic ticker system, according to an example embodiment of the present disclosure.

FIG. 3 shows diagrams of example dynamic real estate tickers, according to example embodiments of the present disclosure.

FIGS. 4 and 5 are diagrams that are illustrative of neighborhood information that is displayed by an application after receiving a selection of a neighborhood in a dynamic ticker, according to an example embodiment of the present disclosure.

FIG. 6 is a flow diagram of an example procedure for determining a real estate state of a user for populating a dynamic ticker with relevant real estate information/content, according to an example embodiment of the present disclosure.

FIGS. 7 and 8 show diagrams of example prompts displayed by an application for acquiring user characteristic and/or profile information, according to an example embodiment of the present disclosure.

FIG. 9 shows diagrams of user interfaces displayed by an application on a user device indicative of property information of a current owner, according to an example embodiment of the present disclosure.

### DETAILED DESCRIPTION

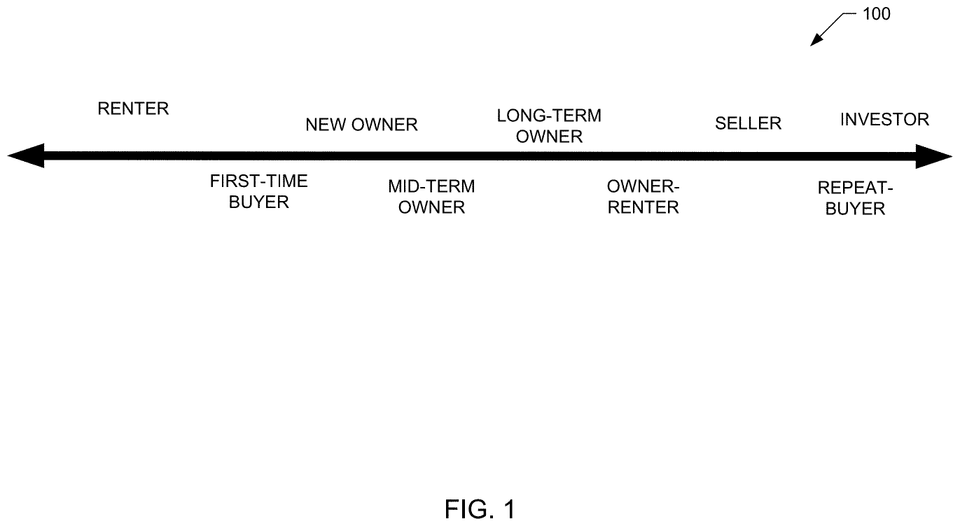

Methods, apparatus, and systems are disclosed herein for providing a dynamic real estate ticker. The example methods, apparatus, and systems are configured to analyze user characteristic and/or profile information to determine a real estate state of a user. FIG. 1 is a diagram that is illustrative of different real estate states of a user 100, according to an example embodiment of the present disclosure. Throughout one's life, a user is at some location along a real estate journey, as shown in FIG. 1. This can include being a renter, a first-time buyer, a new owner, a mid-term owner, a long term-owner, an owner-renter, a seller, a repeat buyer, and/or an investor. Some users can have multiple states at one time, such as being a seller and a repeat-buyer or an owner-renter and a repeat-buyer. A new owner state may correspond to a user who has owned a property for less than three years. A mid-term owner state may correspond to a user who has owned a property between three and ten years, and a long-term owner state may correspond to a user who has owned a property over ten years.

The example methods, apparatus, and systems are configured to determine a real estate state of a user to personalize and/or tailor what information/content is displayed in a dynamic ticker to improve a user's engagement with various real estate services. If the information/content is relevant to a current state of a user, a user is more likely to engage or interact with the information/content. Further, the more relevant the information/content is to a user, the more likely the user is to trust the information/content and related recommendations for real estate services. Moreover, the more relevant the information/content is to a user, the less time a user has to spend searching for information, and potentially viewing competitive websites.

While the use of tickers is not new, the generation of dynamic tickers that include information/content relevant to a user's real estate state is unique. In comparison, stock tickers show various stock prices and most recent changes to the prices. Weather tickers show current or forecast weather in certain locations. While each ticker can be customized to show specific stocks or weather information, the tickers are static in that they are limited only to stock or weather content. Moreover, customization of the tickers occurs via manual user interaction. The disclosed dynamic ticker on the other hand is constantly updated by the methods, apparatus, and systems disclosed herein based on most recent user characteristic and/or profile information and a detected real estate state(s) of the user. As a result, the dynamic ticker may show information relevant to a new buyer before a property purchase, then show information relevant to a new owner of a property (such as property service information) for a time period after a property purchase. In this example, the dynamic ticker may then switch to mortgage refinance information and/or more substantive renovation information after the time period as the user transitions from a new owner to a longer term property owner. The methods, apparatus, and/or systems automatically perform these user real estate transitions based on detected user characteristic and/or profile information rather than being reactive to a user manually entering (if they ever enter) their property information. In some instances, the methods, apparatus, and/or systems may also predict or recommend that a user change a state based on certain identified user characteristic and/or profile information. For example, identification of a large amount of home equity and property prices beginning to fall from historic highs may cause the methods, apparatus, and systems to display in the ticker an alert for a user to sell and/or refinance their property.

Reference is made herein to user characteristic and/or profile information. As disclosed herein, user characteristic and/or profile information includes any information that is related to a user that may be determined or otherwise received by the methods, apparatus, and systems disclosed herein. The user characteristic and/or profile information may be collected by monitoring property-related web browsing information (e.g., reading cookies on a user's web browser or monitoring interaction with a real estate web page/app). The user characteristic and/or profile information may also be entered by a user during a registration process and/or may be obtained from public records, such as property transaction information. The user characteristic and/or profile information may also include third-party variable data sources such as credit scores, employment status (e.g., information from a LinkedIn® profile or company webpage), and/or social media information.

### I. Dynamic Ticker System

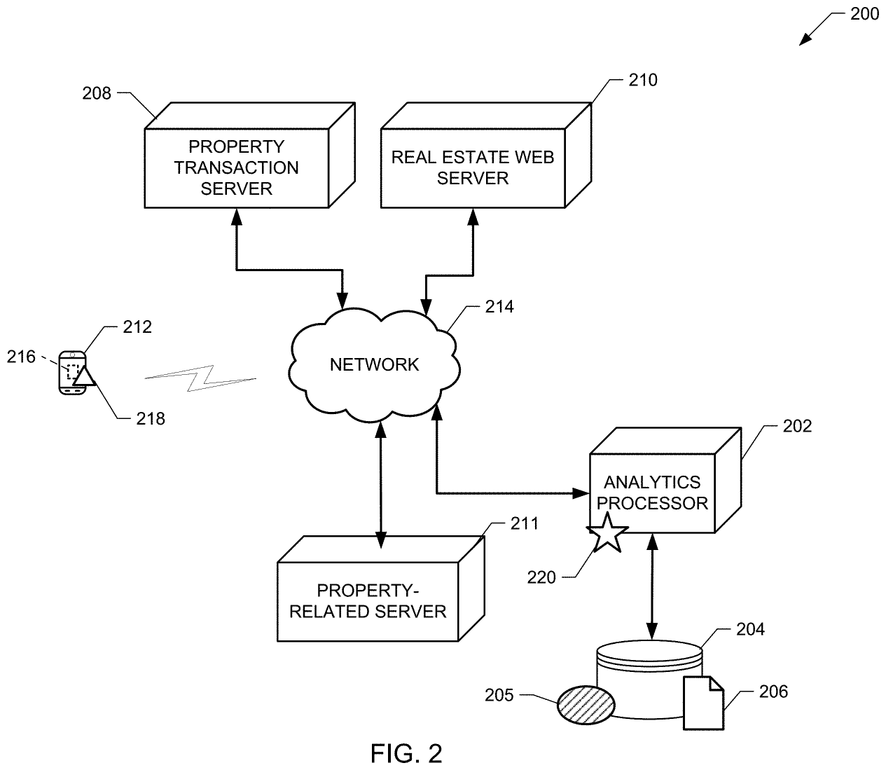

FIG. 2 is a diagram of an example real estate dynamic ticker system 200, according to an example embodiment of the present disclosure. The example system 200 includes an analytics processor 202 communicatively coupled to a memory device 204. The analytics processor 202 may include a server, a cloud computing or distributive computing system, a workstation, a computer, a controller, a processor, a logic circuit, etc. The memory device 204 may include any flash or solid state data storage device including RAM, ROM, EEPROM, an SSD, an HDD, etc.

The example memory device 204 includes one or more computer-readable instructions 205. Execution of the one or more computer-readable instructions 205 by the analytics processor 202 enables the analytics processor 202 to perform the operations described herein. Further, the one or more instructions 205 may define one or more interfaces (e.g., application programming interfaces (“APIs”) for receiving and/or transmitting structured information.

The memory device 204 is configured to store user characteristic and/or profile information 206 for a plurality of users. The memory device 204 may create a data structure, file, record, etc. for each user, which may indicate one or more determined real estate states and/or registration information. The user characteristic and/or profile information 206 includes, for example, property transaction information and/or property-related web browsing information. The property transaction information includes data that is indicative of a property transfer between a buyer and a seller. The property transaction information may include a transaction date, buyer names, seller names, a purchase price, and a property address or identification number. The property transaction information may be accessed or otherwise received from a property transaction server 208 (e.g., a state or county property deed computing system or local news web site).

In addition to above, the property transaction information may also be entered by a user during or after registration with the analytics processor 202. For example, a user may enter a purchase price, mortgage amount, and address of an owned or recently purchased property. The property transaction information may further include rental information for a user, such as rental address, monthly rent, etc.

The property-related web browsing information includes data that is indicative of a user's interaction with one or more websites that relate to property information. The property-related web browsing information may be accessed or otherwise received in the analytics processor 202 from a real estate web server 210. The property-related web browsing information may include real estate searches conducted through a real estate search engine and/or properties viewed through a real estate website or application. In these instances, the property-related web browsing information may include neighborhood property data that is indicative of property addresses, neighborhoods of properties viewed/searched, average sale property price, average property transaction price, an average property square footage, an average year built, a distance from public transportation, public school ranking, an average distance from a body of water, and/or an average distance from a city center, or median property type.

The property-related web browsing information may also include additional information that relates to property ownership. For example, the property-related web browsing information may include information related to browsing mortgage or refinancing information, information related to home services (e.g., landscaping, handyman, snow removal, decorating, maid service, etc.), information related to renovation, information related to property improvements/fixes, and/or information related to property restoration (e.g., information provided by a property-related server 211). The property-related web browsing information may be obtained via cookies or other web usage tracking features on a user device 212. Alternatively, the property-related web browsing information may be obtained via linked user accounts from the real estate web server 210. Further, the property-related web browsing information may be obtained via app usage monitoring on the user device 212. In some instances, the property-related web browsing information may include information from scanning a user's email account and/or social media accounts, if permission is granted.

In the illustrated example of FIG. 2, the user device 212 is communicatively coupled to the analytics processor 202 via a network 214. The example network 214 may include any local area network, wide area network, cellular network, and/or combinations thereof. For example, the network 214 may include a wireless local area network, the Internet, and/or a cellular 5G network.

The user device 212 includes an application 216 configured to display a dynamic ticker 218. The application 216 is defined by one or more instructions stored in a memory device of the user device 212. Execution of the one or more instructions by a processor of the user device 212 causes the user device 212 to perform the operations disclosed herein. The application 216 may include a mobile application, such as a real estate application. In this embodiment, the dynamic ticker 218 is provisioned as a widget of the application 216. In other embodiments, the dynamic ticker 218 may be integrated with the application 216 as standalone widget on the user device 212. In yet other examples, the application 216 may include a web browser. In these other examples, the dynamic ticker 218 may include a plug-in application or active website feature of the web browser. In these embodiments, the dynamic ticker 218 may be installed during browsing of a real estate web site hosted by the real estate web server 210.

In yet other embodiments, the application 216 may include a text-messaging and/or short message service (“SMS”)/reporting+messaging (“RMS”) application. The ticker 218 maybe displayed, for example, in a text message. Alternatively, a text message may include a link, selection of which, causes the ticker 218 to be displayed on the user device 212.

The example dynamic ticker 218 is configured to include real estate content 220. As described below, the analytics processor 202 determines the real estate content 220 for the dynamic ticker 218 using the user characteristic and/or profile information 206. The analytics processor 202 may transmit the real estate content 220 to the user device 212 via one or more APIs for display in the dynamic ticker 218 of the application 216. Alternatively, the analytics processor 202 transmits the real estate content 220 to the real estate web server 210, which includes the real estate content 220 with the plug-in dynamic ticker 218 for the web browser application 216.

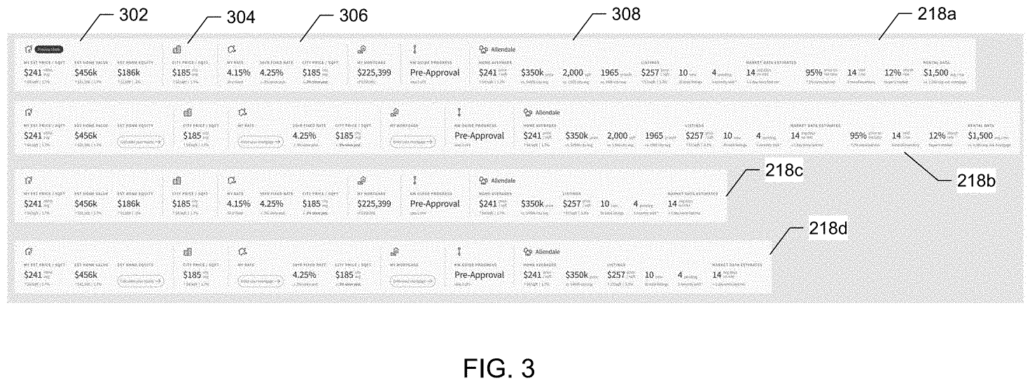

FIG. 3 shows diagrams of example dynamic real estate tickers 218, according to example embodiments of the present disclosure. As shown in FIG. 3, the real estate content 220 included within the ticker 218 is personalized for the user viewing the ticker using the determined real estate state and related user characteristic and/or profile information 206 that is stored in the memory device 204. As such, different (user-targeted) real estate content 220 is provided in dynamic tickers 218 for different users by the analytics processor 202. The content 220 may be stored to a record for a user for selection by the analytics processor 202. Alternatively, the analytics processor 202 stores links in a user's record that point to content 220 for display. In yet alternative embodiments, the analytics processor 220 uses the user characteristic and/or profile information 206 to determine which content 220 is displayed in real-time or near real-time after receiving an indication that the application 216 is active on the user device 212. The analytics processor 202 is configured to, in some examples, determine the real estate content 220 based on property transaction information that is stored within the property transaction server 208 including sales records or mortgage finance/re-finance information for a property purchased by the user in a particular timeframe. The real estate content 220, including property improvement, maintenance, renovation or residential service information, can also be determined from information within the property related server 211.

In the example of FIG. 3, the analytics processor 202 determines a user is classified as having a mid-term owner real estate state and a repeat-buyer real estate state. As a result, the analytics processor 202 creates or identifies real estate content 220 that includes current property information in addition to property for sale information for a neighborhood of interest. The current property information includes a price estimate and home equity of a property owned by the user (i.e., information 302). The current property information also includes current neighborhood information 304 and current mortgage information 306. The information 302 to 306 is generated by the analytics processor 202 after determining the user is a current owner of a property. Additionally, the analytics processor 202 provides neighborhood information 308 because the owner is also determined as being in a repeat-buyer state. The neighborhood information 308 includes average property information for a neighborhood in which the user recently searched for properties or a neighborhood that was determined as a recommended neighborhood. The information 308 includes an average price per square foot, an average sales price, an average square footage, an average property age, average listing information, average market information, and rental information.

The ticker 218b is similar to the ticker 218a but includes prompts to enter mortgage information. The ticker 218c is similar to the ticker 218a but includes less neighborhood information 308. Further, the ticker 218d is similar to the ticker 218c but includes prompts to enter mortgage information.

The example dynamic ticker 218 may display one or more of the information below based on one or more identified real estate states of a user.

Estimated Price/square-foot
Estimate of Dollar/square-foot for a user's home
Percentage change from previous day

Estimated Home Value
Estimated Value of Home based off the value of listings in the same boundary or same set of boundaries
Percentage change from previous day

Estimated Home Equity
Estimated Home Value minus Estimated Mortgage Balance Remaining
Percentage change from previous day

City Price/square-foot
Average Dollar/square-foot for a listing that the User's Home Address is located in
Percentage change from previous day

My Rate (two decimal)
The interest rate the user is paying on their mortgage currently

30 year Fixed Rate
The current daily rate for a 30 year fixed term loan
Percentage change from previous day

15 year Fixed Rate
The current daily rate for a 15 year fixed term loan
Percentage change from previous day

My Mortgage
Balance remaining on existing mortgage. Calculated by determining the amount of principal that has been paid off based upon the home purchase date.

Neighborhood Stock
Average Home Value Price/square-foot
   Determined by summing the total home values of all properties in a neighborhood and dividing by the sum of all the total square footage available within the properties for the neighborhood
   Percentage change from previous day
Average Price
   Average Home Value in that neighborhood
   Average Home Value in the city the neighborhood is located in
Average square-foot
   Average square-foot Value for a Home in that neighborhood
   Average square-foot Value for a Home in the city the neighborhood is located in
Year Built
   Average Year Built for a Home in that neighborhood
   Average Year Built for a Home in the city the neighborhood is located in
Listings Average
   Average Listing Price/square-foot for that neighborhood
   Percentage change from previous day
Number of New Listings in neighborhood
Number of Pending Listings in neighborhood
Average days on Market
   Average number of days listings stayed active (on-market) for that neighborhood for rolling 30 day period
   Delta since last month
Price to List Ratio
   Average of listing sell value versus listing original price in that neighborhood for rolling 30 day period
   Percentage change from previous day
Sold/Month
   Number of listings sold per month in that neighborhood for rolling 30 day period
   Months of Inventory=How many months it would take to sell all active listings that are on market today
Absorption Rate
   Percentage of listings sold vs total number of listings that are active for that neighborhood for rolling 30 day period
   Buyer's Market or Seller's Market
      Buyer—6 Months of Inventory and absorption rate lower than 15%
      Seller—Less than 6 Months of Inventory and absorption rate higher than 15%
Rental Average
   Average rental price for listings in that neighborhood
   Average estimated mortgage price from neighborhood. Derived by calculating all home values and estimated monthly mortgage payment on all homes in the neighborhood, then averaging.

In some embodiments, the analytics processor 202 is configured to analyze a user's user characteristic and/or profile information 206 in combination with market conditions to provide a recommendation to sell and/or refinance their property. The analytics processor 202 may determine, for example, that a user has home equality that is at least 20-25% of an estimated property price. Further, the analytics processor 202 may compare a user's current mortgage rate to current interest rates. The analytics processor 202 may also analyze an estimated price trend of a user's property. Based on this analysis (e.g., high home equity, low rates, and property values just beginning to decline), the analytics processor 202 may display in the ticker 218 information that indicates a user should consider selling or refinancing their mortgage. Selection of this information may cause the analytics processor 202 to display in the application 216 information for selecting a refinance entity or selling their property.

In some instances, the analytics processor 202 may also analyze a user's employment status and/or social media information to predict a state change. For example, the analytics processor 202 may determine that a user changes jobs and/or locations roughly every three years from employment status information and/or social media posts. The analytics processor 202 may accordingly begin displaying seller real estate content 220 in the ticker 218 before the user has even begun searching for new properties. In some instances, the analytics processor 202 may create a user profile or persona that provides a computational model of a user based on acquired user characteristic and/or profile information 206. The user profile may include specific triggers as to when a particular user is more likely to move and/or indicate a sophistication level of a user regarding real estate and/or property management. The analytics processor 202 determines real estate content 220 for display based on the user profile in conjunction with newly received user characteristic and/or profile information 206.

The example analytics processor 202 is configured, in some embodiments, to add recommended neighborhoods and/or other viewed neighborhoods to the dynamic ticker 218. To add the neighborhoods, the analytics processor 202 may store to the real estate content 220 indications of the neighborhoods. Then, when the analytics processor 202 transmits the real estate content 220, the analytical processor 202 accesses current neighborhood information in the memory device 204 for the identified neighborhoods for population into the ticker 218. The application 216 may cause the ticker to scroll such that information about the different neighborhoods is shown in a sequential manner.

To determine recommended neighborhoods, the analytics processor 202 is configured to locate neighborhoods that are within a predetermined distance and/or have similar neighborhood properties as one or more neighborhoods of properties that have been viewed by a user. In other words, the analytics processor 202 identifies neighborhoods that are similar to neighborhoods that a user currently lives and/or neighborhoods that are similar to neighborhoods of properties viewed by a user. The neighborhood properties used in the comparison by the analytics processor 202 may include at least one of an average property transaction price, an average property square footage, an average year built, a distance from public transportation, public school rankings, an average distance from a body of water, and an average distance from a city center, or median property type. In some instances, the predetermined distance is determined by the analytics processor 202 as a function of property density where smaller distances correspond to greater property densities. For example, the analytics processor 202 may not recommend neighborhoods that are further away in a city but may recommend similarly distanced neighborhoods in the suburbs or exurbs.

For users designated as investors, the recommended neighborhoods may include geographic areas where prices have recently decreased compared to historical trends, properties that have characteristics favorable for renting (e.g., condos, starter-homes, located in transit-orientated area, etc.), neighborhoods that have high rental averages (or rental averages compared to purchase price), and/or neighborhoods that have a low purchase price compared to surrounding similar neighborhoods. The analytics processor 202 may be configured to calculate investment trends as the real estate content 220 for the ticker 218. The analytics processor 202 may also display the favorable neighborhood investment information in the ticker 218 with an indication or highlight of the values that show why the data is favorable for investment.

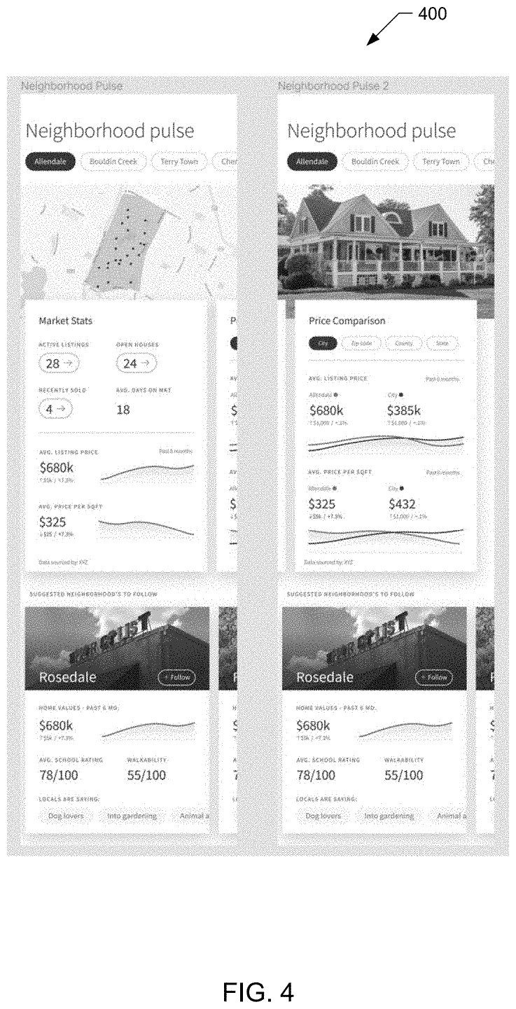

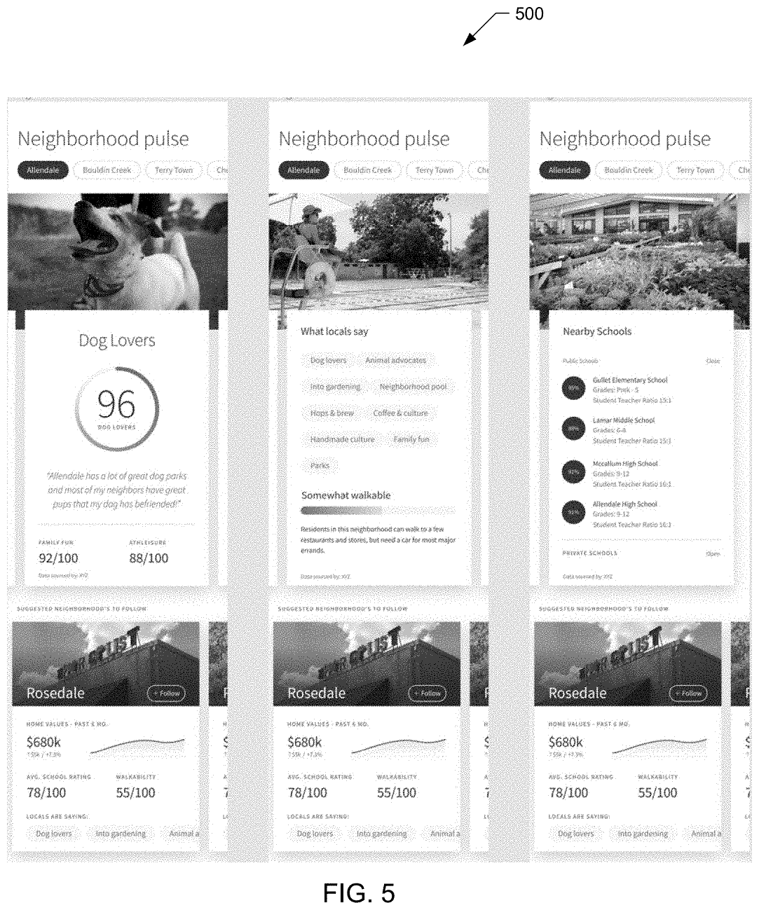

In some embodiments, the analytics processor 202 is configured to provide comparisons between properties for different time periods. For example, the application 216 may enable a user to specify a time period for comparison including a past week, month, two months, six months, year, two years, five years, etc. Additionally, the application 216 may be configured to enable a user to provide a date range for comparing one or more neighborhoods. Selection of a time period or a data range causes the analytics processor 202 to identify neighborhood data for the time period and/or date range, compute the corresponding statistics (e.g., average sale price, average square footage, etc.), and display the comparison within the ticker 218 and/or within one or more neighborhood comparison user interfaces, as shown and described below in connection with FIGS. 4 and 5. As part of the computed statistics, the analytics processor 202 also determines a delta for the specified time period or date range. For a time period, the delta may show how the neighborhood statistics changed from a beginning of the time period to a current time. For a date range, the delta may show how the neighborhood statistics changed from a beginning of the date range to an end of a date range. Such information enables a buyer, seller, and/or investor to see different neighborhoods from an absolute and a relative standpoint.

Selection of neighborhood information in the dynamic ticker 218 causes the analytics processor 202 to show additional information about the neighborhood (e.g., neighborhood pulse information). FIGS. 4 and 5 are diagrams that are illustrative of neighborhood information that is displayed by the application 216 after selecting a neighborhood in the dynamic ticker, 218 according to an example embodiment of the present disclosure. FIG. 4 shows that neighborhood information 400 may include a map highlighting the neighborhood including properties for sale. The neighborhood information may also include market statistics and trends of average sale prices. The neighborhood information 400 may also provide a price comparison to other neighborhoods listed in the ticker 218, a comparison to a current neighborhood of the owner, and/or a comparison to other similar neighborhoods.

As shown in FIG. 5, neighborhood information 500 may include available recommended neighborhoods, providing an easy comparison for a user. The comparison may include neighborhood property information that is determined by the analytics processor 202 as being important to a user, such as an availability of dog parks, neighborhood features, walkability information, and school rating information. It should be appreciated that the neighborhood information 500 is not limited to the information shown in FIG. 5, but can include any information that is available or determined from neighborhood/city/town/county information databases.

As shown in FIGS. 4 and 5, the neighborhood information 400 and 500 determined by the analytics processor 202 provides a comparison between user-selected and/or recommended neighborhoods. A user may select a neighborhood for comparison from a list or map of available neighborhoods. Additionally or alternatively, the application 216 is configured to enable a user to select boundaries to create a user-defined neighborhood. The boundaries may be defined by entering street names and/or addresses. Alternatively, the boundaries may be defined by drawing a space or specifying an area on a map. Selection of the neighborhood (from a list or as a user-defined area) causes the analytics processor 202 to determine the neighborhood information 400 and 500, which may be computed from available data from the servers 208, 210, and 211 and/or stored in the memory device 204.

In addition to above, the neighborhood information 400 and 500 may provide a comparison to other similar properties. In an example, a user may want to view comparisons of 4 bedroom, 4 bathroom properties within a wide geographic area (e.g., the Austin, Texas area). This selection causes the analytics processor 202 to identify properties that have 4 bedrooms and 4 bathrooms and calculate corresponding property statistics that are displayed as the neighborhood information 400 and 500. Such information may show a user how similar properties are priced and have changed over time in separate areas of a city regardless of whether the neighborhoods compare favorably. The analytics processor 202 may receive the property information as entered by a user into the application 216 and/or based on property search criteria.

Other neighborhood information may include
Active Listings
   Listings available currently for sale
Open Houses
   Listings available for sale that have an upcoming open house
Recently Sold
   Listings that may have been recently sold
Average Days on Market
Listings Average Value
   Average Listing Home Value for that neighborhood
   Average Listing Home Value for that zip code
   Average Listing Home Value for that city
   Average Listing Home Value for that county
   Average Listing Home Value for that state
   Percentage change from past 6 months
Listing Price/square-foot Average
   Average Listing Price/square-foot for that neighborhood
   Average Listing Price/square-foot for that zip code
   Average Listing Price/square-foot for that city
   Average Listing Price/square-foot for that county
   Average Listing Price/square-foot for that state
   Percentage change from past 6 months

### II. User Real Estate State Embodiment

As discussed above, in some embodiments the analytics processor 202 is configured to determine a real estate state of a user (e.g., the user 100 of FIG. 1) to determine which real estate content 220 is to be included within the dynamic ticker 218. In the examples discussed above in connection with FIGS. 3 to 5, the user was determined by the analytics processor to be a repeat-buyer and a mid-term owner. It should be appreciated that different real estate content 220 is displayed by the ticker 218 by the analytics processor 202 based on a real estate state of the user 100. As discussed in connection with FIG. 1, available real estate states include renter, first-time buyer, repeat-buyer, new owner, mid-term owner, long-term owner, owner-renter, and/or seller.

The analytics processor 202 uses the user characteristic and/or profile information 206 to determine a real estate state. For example, the analytics processor 202 may use property transaction information to determine if a user has purchased a property, and if so, how long the user has owned the property. This determination enables the analytics processor 202 to determine the user is either a new owner, mid-term owner, long-term owner, and/or owner-renter based on when the property transaction occurred. The determination also enables the analytics processor 202 to determine that the user may be a seller if it is determined that the property-related web browsing information is indicative of the user looking at different properties. The lack of property ownership information enables the analytics processor 202 to determine that the user may be a first-time buyer and/or a renter.

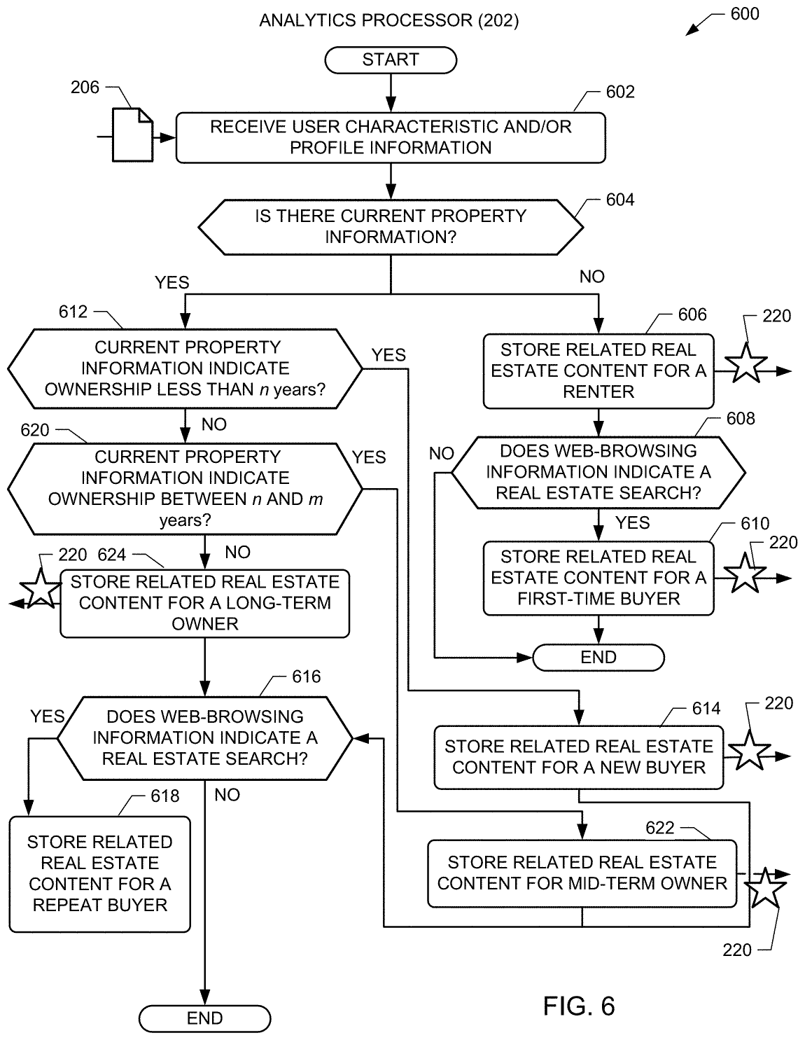

FIG. 6 is a flow diagram of an example procedure 600 for determining a real estate state of a user for populating a dynamic ticker with relevant real estate information, according to an example embodiment of the present disclosure. Although the procedure 600 is described with reference to the flow diagram illustrated in FIG. 6, it should be appreciated that many other methods of performing the steps associated with the procedure 600 may be used. For example, the order of many of the blocks may be changed, certain blocks may be combined with other blocks, and many of the blocks described may be optional. In an embodiment, the number of blocks may be changed based on the number of different types of real estate states configured for the analytics processor 202. The actions described in the procedure 600 are specified by one or more instructions that are stored in the memory device 204, and may be performed among multiple devices including, for example, the analytics processor 202, the user device 212, and/or the application 216.

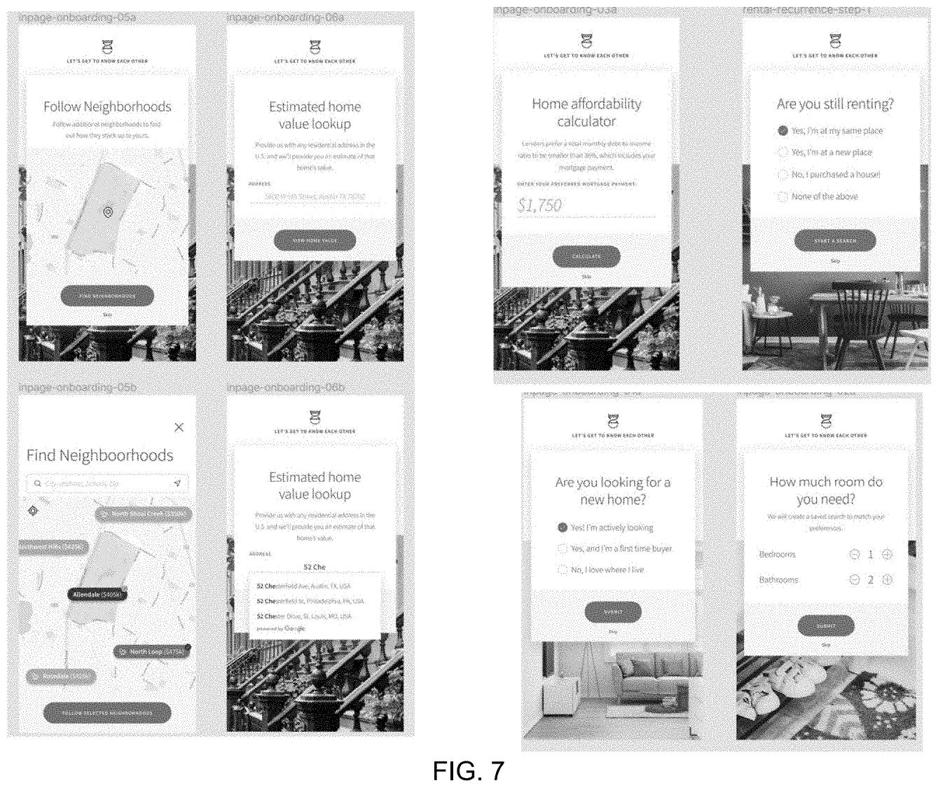

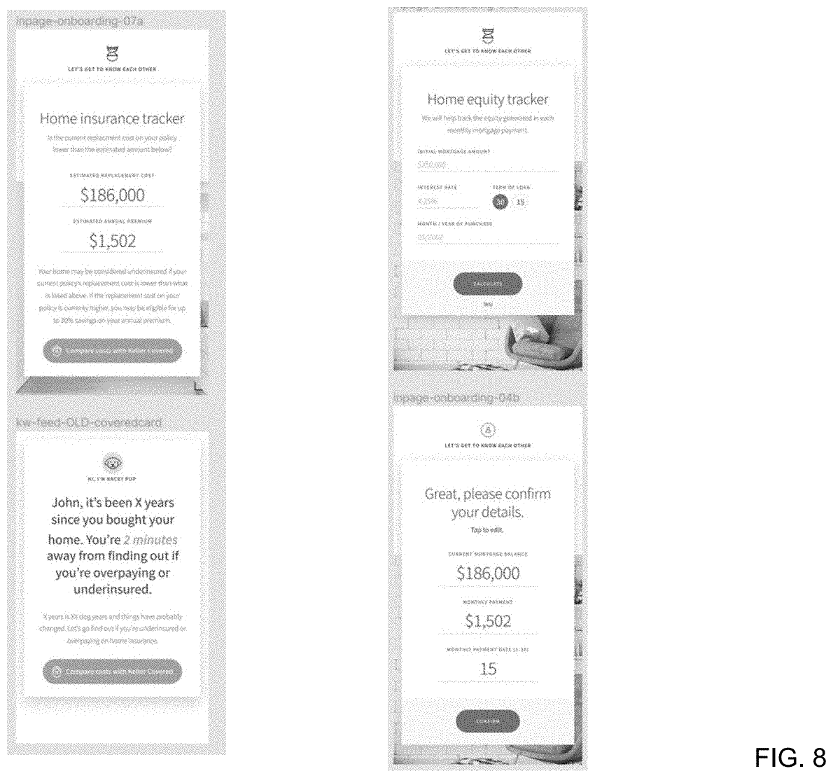

The example procedure 600 begins when the analytics processor 202 receives user characteristic and/or profile information 206 for a specified user (block 602). The information 206 may be stored in the memory device 204 and received from one or more servers 208, 210, and/or 211. FIGS. 7 and 8 show diagrams of example prompts displayed by the application 216 for acquiring user characteristic and/or profile information 206. The prompts may be displayed per an instruction from the analytics processor 202. The prompts include, for example, an entry of a neighborhood to search/follow, a request to lookup a value of a property of interest, a neighborhood search entry, a home affordability calculator, information indicative of renting/looking for a new home, and/or desired property information. As shown in FIG. 8, other prompts may include requests for current mortgage information, current home address, property insurance information, appliance/repair information, property service information, and/or property renovation information. It should be appreciated that the analytics processor 202 may also/alternatively acquire at least some of the user characteristic and/or profile information 206 from one or more of the servers 208, 210, and 211. For example, the analytics processor 202 may access the property transaction server 208 to determine if a user is listed as a buyer or seller in real estate transaction records.

Returning to FIG. 6, the analytics processor 202 next determines if the information 206 includes current property information for the user (block 604). The current property information may include a property transaction record that is indicative that the user is a current owner of a designated property. If no property information is available, the analytics processor 202 determines that the user is likely a renter and accordingly stores real estate content 220 to the memory device 204 in a record for the user that is indicate of a renter real estate state (block 606). As such, when the user views the application 216 on the user device 212, the dynamic ticker 218 is configured to include information relevant to a renter such as available rentals in the same neighborhood or similar neighborhoods, moving information, and/or price comparisons between buying and renting.

The analytics processor 202 next determines if the user characteristic and/or profile information 206 is indicative as to whether the user has performed one or more real estate searches (block 608). If the information does not include real estate search information, the analytics processor 202 determines the user is only a renter and the procedure 600 ends. Alternatively, the procedure 600 may repeat when additional user characteristic and/or profile information 206 is received.

However, if there is information indicative of a real estate search, the analytics processor 202 determines the user is a first-time buyer. The analytics processor 202 accordingly stores content 220, links to content 220, and/or stores information for accessing related content 220 to a record associated with the user. The analytics processor 202 may also store to the record information indicative of (and/or designated for) the first-time buyer state (block 610). This may include recent property information, neighborhood information, recommended neighborhood information, mortgage information, agent information, inspection information, moving information, etc. The example procedure 600 then ends or returns to block 602 when additional information 206 is received for the user.

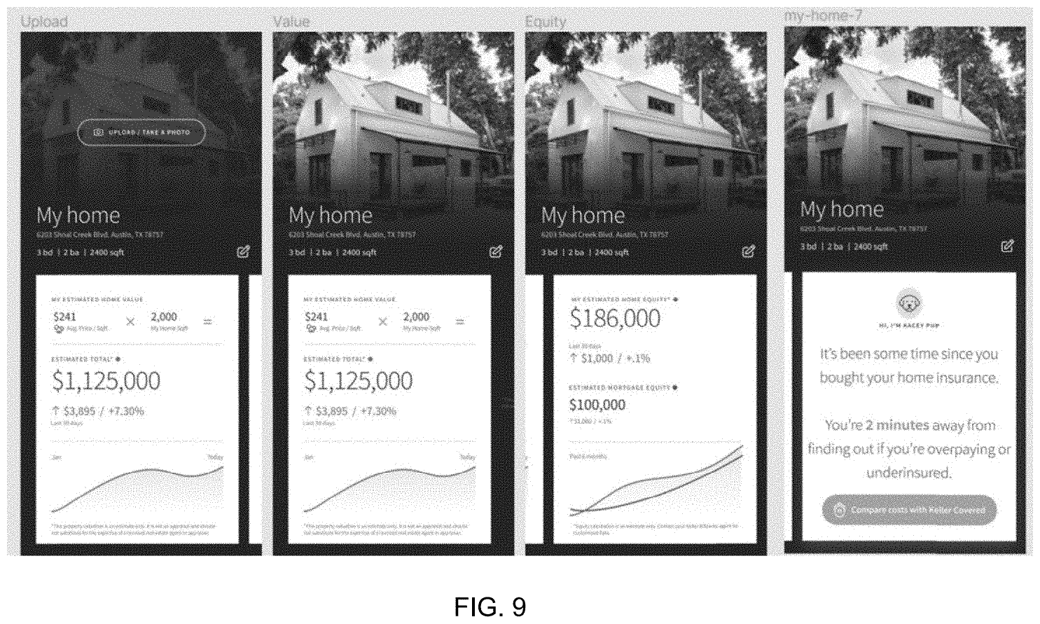

Returning to block 604, the analytics processor 202 determines how long a user has owned a property. The determination may be made based on information prompted from a user, provided at registration, and/or determined from property records. The analytics processor 202 may determine if the user owned a property for less than n years, where n is between three months and four years, as determined by a systems administrator (block 612). If the property has been owned for less than n years, the user is identified as a new-owner and the analytics processor 202 accordingly stores a new-owner state and related real estate content information to a record of the user (block 614). This may include indications to display information about real estate property services, cleaning, repair, etc. FIG. 9 shows user interfaces displayed by the application 216 on the user device 212 indicative of property information of a current owner. The information shown in FIG. 9 may be displayed after a user selected a corresponding feature in the dynamic ticker 218, such as current property information, insurance information, and/or home equity information.

The analytics processor 202 then determines if web-browsing information indicates a real estate search has been conducted by a user (block 616). If so, the user is also deemed a repeat buyer and the respective state is stored to the memory device 204 (block 618). Accordingly, in addition, to receiving information for a new-owner, the analytics processor 202 also displays in the dynamic ticker 218 information for a repeat buyer including neighborhood information. If there is no search information, the procedure 600 ends or returns to block 602 for new user characteristic and/or profile information.

Returning to block 612, the analytics processor 202 determines if the user has owned the property greater than n years but less than m years (block 620). If so, the analytics processor 202 identifies the user as a mid-term owner and accordingly stores an indication to a record of the user (block 622). This state may cause the analytics processor 202 to display mid-term owner information in the dynamic ticker including property renovation information, home equity information, refinance information, property service information, etc. The analytics processor 202 then determines if web-browsing information indicates a real estate search (block 616). If so, the user is also deemed a repeat buyer and the respective state (and/or content 220/links to content 220) is stored to the memory device 204 (block 618). If there is no search information, the procedure 600 ends or returns to block 602 for new user characteristic and/or profile information.

Returning to block 620, the analytics processor 202 determines the user has owned the property greater than m years (block 624). The analytics processor 202 identifies the user as a long-term owner and accordingly stores an indication to a record of the user. This state may cause the analytics processor 202 to display long-term owner information in the dynamic ticker 218 including property reconstruction (remodel) information, refinance information, property service information, owner-rental information, home equity information, etc. The analytics processor 202 then determines if web-browsing information indicates a real estate search (block 616). If so, the user is also deemed a repeat buyer and the respective state is stored to the memory device 204 (block 618). If there is no search information, the procedure 600 ends or returns to block 602 for new user characteristic and/or profile information.

As provided above, the example procedure 600 identifies one or more real estate states of a user, which helps determine which real estate content is to be included within a dynamic ticker. The example procedure 600 accordingly automatically reflects an ownership journey of a user, which is used by the analytics processor 202 to provide property information/content that is most relevant to a user. Overtime, the example procedure 600 detects when a user transitions from one or more real estate states to a different real estate state, such as from renter to first-time buyer. This configuration should help increase a user's engagement with the ticker. This configuration should also increase a user's use of services that are displayed by the ticker such that engagement does not end after a user rents or purchases real estate.

### III. Conclusion

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for generating a dynamic real estate ticker for a user device of a user, the system comprising:
a memory device storing user characteristic and profile information for a user to receive the dynamic ticker, the user characteristic and profile information including property transaction information and property-related web browsing information; and
an analytics processor communicatively coupled to the memory device, the analytics processor configured to:
determine a real estate state of the user, among a plurality of available real estate states, based on the property transaction information and the property-related web browsing information, the plurality of available real estate states including at least three of a first-time buyer, a repeat-buyer, a new owner, a mid-term owner, a long-term owner, a renter, an owner-renter, a seller, or an investor,
determine real estate content for the dynamic ticker based on the determined real estate state and the property-related web browsing information, and
transmit, to the user device, the determined real estate content for display by the user device within the dynamic ticker.

2. The system of claim 1, wherein the analytics processor is configured to:
determine the real estate state of the user is a new owner based on the property transaction information including a sales record for a property purchased by the user within a past three years; and
determine the real estate content includes property improvement, maintenance, or residential service information.

3. The system of claim 1, wherein the analytics processor is configured to:
determine the real estate state of the user is a mid-term owner based on the property transaction information including a sales record for a property purchased by the user between a past three to ten years; and
determine the real estate content includes property renovation, maintenance, or residential service information.

4. The system of claim 3, wherein the analytics processor is configured to determine the real estate content includes mortgage refinance information.

5. The system of claim 1, wherein the analytics processor is configured to:
determine the real estate state of the user is a long-term owner based on the property transaction information including a sales record for a property purchased by the user over ten years ago; and
determine the real estate content includes property reconstruction or remodel information.

6. The system of claim 1, wherein the analytics processor is configured to:
determine the real estate state of the user is a first-time buyer based on the property transaction information not including a sales record that is related to the user and the property-related web browsing information including real estate listings for purchase; and
determine the real estate content includes neighborhood information including at least one of an average transaction price, an average square footage, an average year built, or real estate market data information.

7. The system of claim 6, wherein selection of the neighborhood information in the dynamic ticker causes the analytics processor to display real estate listings on the user device that are related to a neighborhood related to the neighborhood information.

8. The system of claim 7, wherein the neighborhood includes at least one of a town district or zone, a zip code, a town or city, a county, or a state.

9. The system of claim 6, wherein the analytics processor is configured to determine the real estate content includes at least one of mortgage information, property insurance information, escrow information, title information, survey information, or inspection information.

10. The system of claim 1, wherein the analytics processor is configured to:
determine the real estate state of the user is a repeat-buyer based on the property transaction information including at least one sales record for a property purchased by the user and the property-related web browsing information including real estate listings for purchase; and
determine the real estate content includes neighborhood information including at least one of an average transaction price, an average square footage, an average year built, or real estate market data information.

11. The system of claim 10, wherein selection of the neighborhood information in the dynamic ticker causes the analytics processor to display real estate listings on the user device that are related to a neighborhood related to the neighborhood information.

12. The system of claim 10, wherein the analytics processor is configured to:
receive, as new property-related web browsing information, information related to properties viewed in a new neighborhood; and
determine, as new real estate content for the dynamic ticker, new neighborhood information that is related to properties viewed in the new neighborhood.

13. The system of claim 10, wherein the analytics processor is configured to:
determine recommended neighborhoods based on the neighborhood information including locating neighborhoods that are within a predetermined distance and have similar neighborhood properties as one or more neighborhoods included within the neighborhood information; and
determine, as new real estate content for the dynamic ticker, new neighborhood information that is related to the recommended neighborhoods.

14. The system of claim 13, wherein the neighborhood properties include at least one of an average property transaction price, an average property square footage, an average year built, a distance from public transportation, a public school ranking, an average distance from a body of water, an average distance from a city center, or median property type.

15. The system of claim 13, wherein the predetermined distance is determined by the analytics processor as a function of property density where smaller distances correspond to greater property densities.

16. The system of claim 1, wherein the analytics processor is configured to:
determine a user is to sell a property based on the user characteristic and profile information including home equity information and market conditions of the property beginning to decline from a near-term high; and
transmit, to the user device, an alert indicative of a recommendation to sell the property for display by the user device within the dynamic ticker.

17. A method for generating a dynamic real estate ticker for a user device of a user, the method comprising:
storing, to a memory device, user characteristic and profile information for a user, the user characteristic and profile information including property transaction information and property-related web browsing information;
determining, via an analytics processor communicatively coupled to the memory device, a real estate state of the user, among a plurality of available real estate states, based on the property transaction information and the property-related web browsing information, the plurality of available real estate states including at least three of a first-time buyer, a repeat-buyer, a new owner, a mid-term owner, a long-term owner, a renter, an owner-renter, a seller, or an investor;
determining, via the analytics processor, real estate content for the dynamic ticker based on the determined real estate state of the user and the property-related web browsing information; and
transmitting, from the analytics processor to the user device, the determined real estate content for display by the user device within the dynamic ticker.

18. The method of claim 17, further comprising:
determining, via the analytics processor, the real estate state of the user is a new owner when the property transaction information includes a sales record for a property purchased by the user within a past three years;
determining, via the analytics processor, the real estate state of the user is a mid-term owner when the property transaction information includes a sales record for a property purchased by the user between a past three to ten years;
determining, via the analytics processor, the real estate state of the user is a long-term owner when the property transaction information includes a sales record for a property purchased by the user over ten years ago;
determining, via the analytics processor, the real estate content includes property improvement, maintenance, and residential service information when the real estate state is the new owner;
determining, via the analytics processor, the real estate content includes property renovation, maintenance, mortgage refinance information, and residential service information when the real estate state is the mid-term owner; and
determining, via the analytics processor, the real estate content includes property reconstruction or remodel information when the real estate state is the long-term owner.

19. The method of claim 17, further comprising:
determining, via the analytics processor, the real estate state of the user is a first-time buyer when the property transaction information does not include a sales record that is related to the user and the property-related web browsing information includes real estate listings for purchase;
determining, via the analytics processor, the real estate state of the user is a repeat-buyer when the property transaction information includes at least one sales record for a property purchased by the user and the property-related web browsing information includes real estate listings for purchase;
determining, via the analytics processor, the real estate content includes neighborhood information including at least one of an average transaction price, an average square footage, an average year built, or real estate market data information when the real estate state is the first-time buyer; and
determining, via the analytics processor, the real estate content includes neighborhood information including at least one of an average transaction price, an average square footage, an average year built, or real estate market data information when the real estate state is the repeat-buyer.

20. The method of claim 19, further comprising:
receiving a message from the user device in the analytics processor indicative of a selection of the neighborhood information in the dynamic ticker;
determining, via the analytics processor, real estate listings that are related to a neighborhood related to the neighborhood information; and
transmitting, from the analytics processor to the user device, the real estate listings for display.
